(19) United States
(12) Patent Application Publication
(10) Pub. No.: US 2026/0135798 A1
(43) Pub. Date: May 14, 2026

(54) SYSTEMS AND METHODS FOR CONFIGURING AN OVERLAY NETWORK

(71) Applicant: Adeia Guides Inc., San Jose, CA (US)

(72) Inventors: Dhananjay Lal, Englewood, CO (US); Reda Harb, Saint Petersburg, FL (US)

(21) Appl. No.: 18/947,983

(22) Filed: Nov. 14, 2024

(51) Int. Cl. H04L 45/24; H04L 41/0806; H04L 43/10

(52) U.S. Cl. CPC H04L 45/24; H04L 41/0806; H04L 43/10

(57) ABSTRACT

Systems and methods are provided for configuring an overlay network. A transport session is initiated at a first relay computing device of the overlay network, and a first portion of a content item is transmitted via a first routing path comprising the first relay computing device. An overlay network reconfiguration event is identified, and a second relay computing device is identified based on the overlay network reconfiguration event. A second routing path is formed by adding the second relay computing device to the first routing path. A termination message indicating that the transport session must be ended is transmitted to the first relay computing device, and the first relay computing device is removed from the second routing path based on the termination message. A second portion of the content item is transmitted via the second routing path comprising the second relay computing device.

The present disclosure is generally directed to systems and methods for configuring an overlay network.

### SUMMARY

With the widespread availability of relatively fast and stable Internet connections, many people stream media, such as television programs, via the Internet; however, delivering media to a computing device, such as a smart television, via the Internet is a relatively resource-intensive process. Streaming media via the Internet typically utilizes the transmission control protocol (TCP); however, TCP was developed and implemented before the widespread adoption of media streaming, and, as such, there are limitations around latency and bandwidth. One approach to address these limitations has been the widespread adoption of adaptive bitrate streaming (ABR), particularly by over-the-top (OTT) platforms; however, ABR still typically utilizes TCP. Another approach has been to replace the TCP protocol altogether when streaming media over the Internet. One such replacement protocol is the quick user datagram protocol (UDP) Internet connection (QUIC) protocol developed by the Internet Engineering Task Force. In particular, HTTP/3 is built using QUIC as its transport mechanism. One approach to deliver media over QUIC is the media over QUIC transport (MOQT) protocol, which enables a producer of media to publish media and have it consumed by a plurality of endpoints. MOQT enables relays to form one or more overlay delivery networks that are independent of the publisher to enable the media content to be delivered via the Internet. These overlay delivery networks may be similar in functionality to content delivery networks (CDNs). As these relays are independent of the publisher, they may come and go without notice and/or suffer from performance variations. As such, there is a need for MOQT networks to be reconfigured in order to enable the improved quality of service for the delivery of media via a MOQT network. Example reconfigurations may include removing and/or adding one or more relays to an overlay network.

To help address these problems, systems and methods are provided for configuring an overlay network.

In accordance with some aspects of the disclosure, a method for configuring an overlay network is provided that includes initiating a transport session at a first relay computing device of the overlay network, and transmitting a first portion of a content item via a first routing path comprising the first relay computing device. An overlay network reconfiguration event is identified, and a second relay computing device is identified based on the overlay network reconfiguration event. A second routing path is formed by adding the second relay computing device to the first routing path, and a termination message indicating that the transport session must be ended is transmitted to the first relay computing device. The first relay computing device is removed from the second routing path based on the termination message, and a second portion of the content item is transmitted via the second routing path comprising the second relay computing device.

In some examples, an OTT provider, such as Disney+, utilizes an overlay relay network to deliver content items, such as television programs and movies, to consumer computing devices, such as smart televisions, tablets, smartphones, laptops, PCs and/or smart speakers. A transport session is initiated at a first relay server of the overlay network, and a first portion, such as a first segment of the content item is transmitted to a consumer computing device via a first routing path comprising the first relay computing device. In response to detecting that the first relay server has suffered a loss of available bandwidth, a second routing path is formed by adding a second relay server to the first routing path. A termination message, such as a GOAWAY message, is transmitted to the first relay server, and the first relay server is subsequently removed from the second routing path. A second portion, such as a second segment of the content item is then transmitted via the second routing path comprising the second relay server to the consumer computing device.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows a schematic diagram of a system for reconfiguring an overlay network, in accordance with some embodiments of the disclosure;

FIG. 2A shows another schematic diagram of a system for reconfiguring an overlay network, in accordance with some embodiments of the disclosure;

FIG. 2B shows another schematic diagram of a system for reconfiguring an overlay network, in accordance with some embodiments of the disclosure;

FIG. 3 shows a flowchart of illustrative steps for enabling the reconfiguration of an overlay network, in accordance with some embodiments of the disclosure;

FIG. 4 shows a flow diagram of illustrative steps for enabling the reconfiguration of an overlay network;

FIG. 5 shows another flowchart of illustrative steps for enabling the reconfiguration of an overlay network, in accordance with some embodiments of the disclosure;

FIG. 6 shows another flowchart of illustrative steps for enabling the reconfiguration of an overlay network, in accordance with some embodiments of the disclosure;

FIG. 7 shows another flowchart of illustrative steps for enabling the reconfiguration of an overlay network, in accordance with some embodiments of the disclosure;

FIG. 8 shows another flowchart of illustrative steps for enabling the reconfiguration of an overlay network, in accordance with some embodiments of the disclosure;

FIG. 9 shows another flowchart of illustrative steps for enabling the reconfiguration of an overlay network, in accordance with some embodiments of the disclosure; and

FIG. 10 shows a block diagram representing components of a computing device and dataflow therebetween for enabling the reconfiguration of an overlay network, in accordance with some embodiments of the disclosure.

### DETAILED DESCRIPTION

A content item includes audio, video, text, a video game and/or any other media content. A live content item may be a content item that is broadcast at the same time, or at substantially the same time, as an event that is being captured for broadcast. In another example, a live content item may be a content item that is broadcast at a scheduled time, such as an episode of a show. A content item may be a single media item. In other examples, it may be a series (or season) of episodes of content items. Video includes audiovisual content such as movies and/or television programs or portions thereof. Audio includes audio-only content, such as podcasts or portions thereof. Text includes text-only content, such as event descriptions or portions thereof.

In some examples, a node that a broadcaster connects to may be called a producer node, and a node that a viewer connects to may be called a consumer node. A broadcaster may upload a media content item, including live content, to the producer node, where the producer node may process the media content item (e.g., transcode, package and/or insert advertising) if needed. A consumer node may receive requests from consumer, or viewer, computing devices. If a consumer node is already serving a content item stream, and has recent video frames cached, it may immediately respond with the content item. Otherwise, the consumer node may initiate a path lookup request to a central control plane with, for example, a stream ID as the input. The overlay path returned may dictate how the content item can be transmitted from the producer node to the consumer nodes, potentially via intermediate nodes (relays). These relays may cache video content and may be used to construct arbitrary path topologies.

An overlay network is any suitable virtual or logical network for delivering a content item over a physical network, such as the Internet. Typically, an overlay network comprises at least one sending computing device, at least one relay computing device and at least one receiving computing device. The sending computing device may receive a portion of a content item and transmits it to a relay computing device. The relay computing device may transmit the portion of the content item to another relay computing device and/or to a receiving computing device, such as a smart television, tablet, smartphone, laptop, PC and/or smart speaker. The sending and/or relay computing devices may comprise one or more physical and/or virtual servers. In some examples, the relay computing devices may be part of one or more third-party networks, independent of both a publisher of a media content item, and a subscriber to the media content item. The relay computing device may cache content for distribution efficiency while simultaneously routing content and deterministically responding to congestion in a multi-tenant network. In MOQT, a relay may be the equivalent of a CDN point of presence that is involved in the delivery of content items, such as live and/or real-time media.

A routing path includes a path that data packets take from a source to a destination across a network. The path may be a physical and/or virtual path. The data packets may be content item data packets. A source may be a server on which a content item is stored. A destination may comprise a plurality of destinations including, for example, one or more of a smart television, tablet, smartphone, laptop, PC and/or smart speaker. A routing path may comprise one or more relay computing devices, and the path may be reconfigured (or a new path formed) by adding and/or removing one or more relay computing devices to/from the path. In some examples, the path may be reconfigured in response to, or based on, an overlay network reconfiguration event.

A network reconfiguration event includes any event that may be utilized to trigger a change in a routing path. In some examples, a heartbeat signal may be received from, for example, a relay computing device, and a change in the heartbeat signal may be identified as a network reconfiguration event. In another example, a network reconfiguration event may comprise identifying that a relay device has suffered a loss of bandwidth. In a further example, a number of consumers of a content item over a routing path may increase to the extent that a further relay device needs to be added to the routing path in order to satisfactorily manage the traffic associated with delivering the content item to the consumers.

A further relay device or node, such as a second relay device or a new relay device, may be added to a routing path based on a network reconfiguration event. This further relay device may be provisioned before it is configured to be addable to an overlay network. In other examples, the further relay device may be provisioned in response to a network reconfiguration event, and added to the overlay network after it has been provisioned, or during the provisioning. In some examples, the provisioning may comprise provisioning the relay device based on a cause of the network reconfiguration event, for example, to optimize the relay device to be less likely to suffer from an issue that triggered the network reconfiguration event.

A heartbeat signal is any signal that is received from another computing device including one or more relay and/or client computing devices. The heartbeat signal may be a signal that is transmitted at a fixed interval, or period. In other examples, the heartbeat signal may be transmitted regularly, such as in response to a change in conditions. A heartbeat signal may also indicate that conditions have not changed, and the lack of signal may indicate a network reconfiguration event. The heartbeat signal may comprise a suitable metric including, for example, a rebuffing ratio, a content item start up time, a number of content item start failures, an average bitrate of a content item, an average frame rate of a content item and/or a rendering quality of a content item.

Messages such as termination messages and subscribe messages may be used to control one or more aspects of an overlay network. An example of a termination message is a media over QUIC (MOQ) GOAWAY message and an example of a subscribe message is a MOQ SUBSCRIBE message. A GOAWAY message includes instructions to initiate a graceful shutdown of a connection so that a computing device may stop accepting new requests while still finishing the processing of previously received requests. A SUBSCRIBE message includes instructions to send data, such as content item data, to a device or relay that wants to receive a content item.

MOQT typically requires a long-lived and stateful session; however, a service provider may require the ability to shut down and/or restart a server without waiting for all sessions to drain naturally, when in some cases may take days for long-form media. MOQT avoids this via the GOAWAY message. A server may send a GOAWAY message, signaling that a client should establish a new session and migrate any active subscriptions. The GOAWAY message may contain a new uniform resource indicator (URI) for the new session; otherwise the current URI may be reused. In some examples, a GOAWAY message may be used by relays to selectively redistribute some downstream nodes, for example, consumers to other relays.

The quality of a content item may comprise one or more of a resolution and/or bitrate of the content item. For example, a high-quality content item may have a relatively high resolution, bitrate, dynamic range, number of audio channels and/or framerate, and a low-quality content item may have a relatively low resolution, bitrate, dynamic range, number of audio channels and/or framerate. In some examples, a high-quality content item may be a 2K resolution content item with a high dynamic range and 7.1 sound, and a low-quality content item may be a 720p resolution content item, with a low dynamic range and 2.1 sound.

The disclosed methods and systems may be implemented on one or more devices, such as user devices and/or computing devices. As referred to herein, the device can be any device comprising a processor and memory, for example, a handheld computer, a mobile telephone, a portable video player, a portable music player, a portable gaming machine or console, a smartphone, a smartwatch, a smart speaker, an augmented reality headset, a mixed reality device, a virtual reality device, a gaming console, a vehicle infotainment headend or any other computing equipment, wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM) and/or a solid-state drive.

MOQT utilizes a publish/subscribe workflow in which producers of media publish data, for example via servers, in response to subscription requests from a multiplicity of consumer computing devices. A wide range of media may be delivered via MOQ including, for example, live streaming, gaming, and media conferencing. MOQT-specific mechanisms may be leveraged in order to reconfigure a media delivery overlay network.

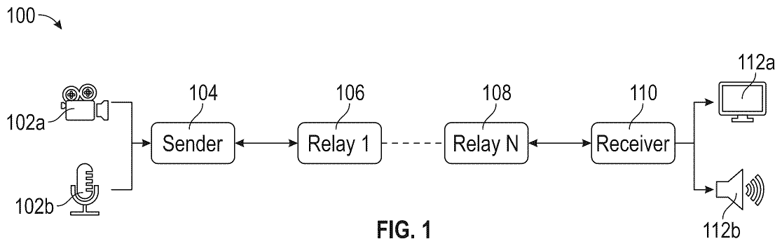

FIG. 1 shows a schematic diagram of a system for reconfiguring an overlay network, in accordance with some embodiments of the disclosure. In some examples, a media delivery overlay network topology may change as producers, consumers and relays change. The environment 100 comprises first and second tracks 102a, 102b of a content item; an overlay network comprising a sender computing device 104, a first relay computing device 106, a second relay computing device 108 and a receiver computing device 110; and a consumer computing device comprising a display 112a and a speaker 112b. In this example, the first track 102a is a video track and the second track 102b is an audio track. One or more of the sender computing devices 104, the first relay 106, the second relay 108 and the receiver computing device 110 may comprise one or more virtual and/or physical servers. The consumer computing device may comprise any computing device including, for example, a smart television, tablet, smartphone, laptop, PC, smart speaker. One or more tracks 102a, 102b are transmitted over the overlay network to the consumer computing device. In this example, the video track 102a and the audio track 102b are transmitted to the sender computing device 104, where they are then transmitted to the first relay computing device 106. In this example, the portions are transmitted over the overlay network viaMOQ. The tracks 102a, 102b are transmitted from the first relay computing device 106 to a second relay computing device 108. In this example, there may be one or more relay devices (not shown) in between the first relay computing device 106 and the second relay computing device 108. On receiving the tracks 102a, 102b, the second relay device 108 transmits the portions to the receiver computing device 110, which transmits the portions to the consumer computing, where the video track 102a is output at the display 112a, and the audio track 102b is output at the speaker 112b.

A basic data element of MOQT is an object. An object is an addressable unit whose payload is a sequence of bytes. All objects belong to a group, indicating ordering and potential dependencies. An object is uniquely identified by its track namespace, track name, group ID, and object ID, and must be an identical sequence of bytes regardless of how or where it is retrieved. Objects are comprised of two parts: metadata and a payload. The metadata is never encrypted and is always visible to relays. The payload portion may be encrypted, in which case it is visible only to the producer and consumer.

MOQT defines a publish-based and/or subscribe-based media delivery protocol, wherein endpoints, called producers, publish objects that are delivered via participating relays to receiving endpoints, called consumers. A track contains a sequence of groups and serves as the entity against which a consumer issues a subscription request. Objects are comprised of two parts: envelope and a payload. The envelope is not end-to-end encrypted, and is visible to relays. The payload portion may be end-to-end encrypted, in which case it is visible only to the producer and consumer. The application is solely responsible for the content of the object payload. Tracks are identified by a combination of its TrackNamespace and TrackName. TrackNamespace and TrackName are treated as a sequence of binary bytes. Group and Objects are represented as variable length integers called GroupId and ObjectId respectively.

MOQT enables fanout, meaning one copy of a media content item may be distributed a large number of times, for example, hundreds and/or thousands of times. For example, a conference call may comprise 100 participants all at the same physical location. With MOQT, a local media relay installed at that physical location may enable fanout, meaning the content from the conference call travels over the network only one time. Copies may be stored in the local media relay and are then distributed within the physical location as many times as necessary.

Efficient fanout may occur if relays are able to aggregate authorized subscriptions for a given track when multiple subscribers request the same track. Subscription aggregation may enable relays to make only a single forward subscription for the track. The published content received from the forward subscription request may be cached and shared among the pending subscribers.

The media flow (comprising a content item) is transmitted from the producer to the consumer, and may go through several relays. The media content may be encrypted using QUIC encryption as requested; however, whether the relay node will terminate a QUIC connection can be dealt with in one of two ways.

The first way is to run the entire MOQT protocol inside QUIC encryption, including the media metadata that is needed, by the relay. In this example, the relay has to terminate the QUIC connection, decrypting the QUIC payload. This may require that each relay node hold a valid certificate authority (CA) certificate and run the CA verification process.

The second way is to encrypt only the media content using QUIC encryption, but to leave the metadata to another non-QUIC mechanism. In this example, the QUIC connection is from producer to consumer, and the relay does not need to decrypt the QUIC payload, thereby saving computing power.

In a traditional CDN network, each CDN site may be viewed as a relay, with those relays organized in a tree. Another approach is to connect the relays in a dynamic mesh instead of a static hierarchy. In this example, a centralized controller may collect the latency between each relay periodically and calculates an optimal path (latency-wise) for each media stream dynamically.

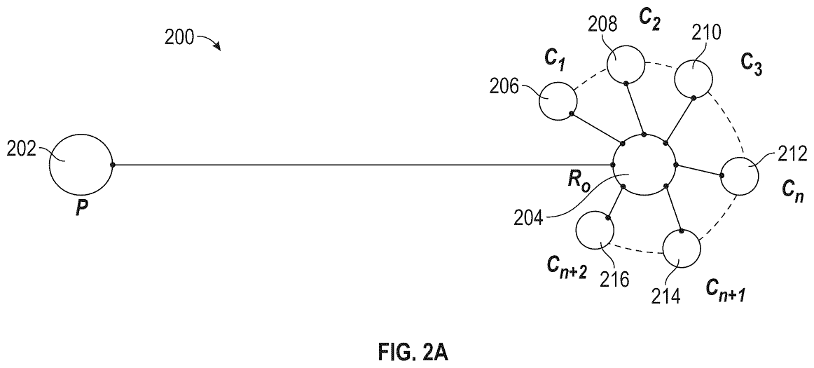

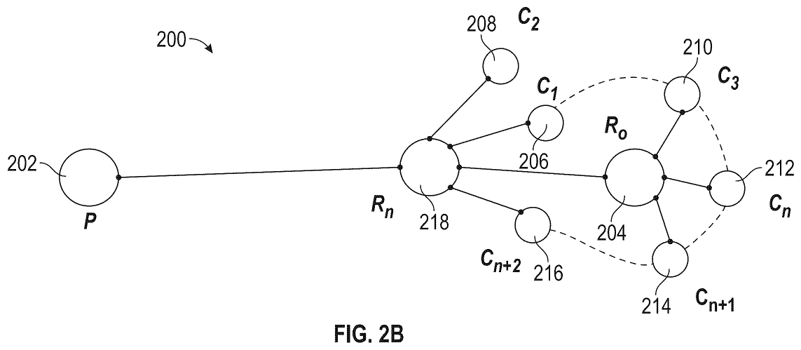

FIGS. 2A and 2B depict an example wherein the overlay network topology is reconfigured after a new relay is available for disseminating a media track. FIG. 2A depicts a producer P that serves consumers C₁ . . . Cₙ₊₂ via relay Rₒ. In FIG. 2B, relay Rₙ is introduced such that some of the consumers (C₃ . . . Cₙ₊₁) are still served by relay Rₒ; however, other consumers C₁, C₂, Cₙ₊₂ are served by the new relay Rₙ. Such a scenario may be particularly relevant when an overlay network is a dynamic mesh.

FIG. 2A shows another schematic diagram of a system for reconfiguring an overlay network, in accordance with some embodiments of the disclosure. The environment 200 comprises a producer computing device 202, a first relay computing device 204 and first to sixth consumer computing devices 206-216. The producer computing device 202 and/or the first relay computing device 204 may comprise one or more virtual and/or physical servers. The consumer computing devices may comprise one or more of a smart television, tablet, smartphone, laptop, PC and/or smart speaker. The producer computing device 202 transmits portions of content items, via an overlay network comprising relay computing device 204, to the first to sixth consumer computing devices 206-216. Although one relay computing device is shown, the overlay network may comprise any number of relay computing devices. Although six consumer computing devices are shown, the portions of the content item may be transmitted to any number of consumer computing devices.

FIG. 2B shows another schematic diagram of a system for reconfiguring an overlay network, in accordance with some embodiments of the disclosure. The environment 200 comprises the producer computing device 202, a first relay computing device 204 and first to sixth consumer computing devices 206-216 and, additionally, a second relay computing device 218. The second relay computing device 218 may comprise one or more virtual and/or physical servers. A network reconfiguration event introduces the second relay computing device 218 into the overlay network, and the overlay network is reconfigured so that the second relay 218 device transmits the portions of the content items to the first, second and sixth consumer computing devices 208, 210, 216 and the first relay computing device 204. The first relay computing device 204 transmits the portions of the content items, received from the second relay computing device 218, to the third, fourth and fifth consumer computing devices 210-214. Although the network reconfiguration event is shown as introducing an additional relay computing device, a network reconfiguration event may introduce and/or remove any number of relay computing devices.

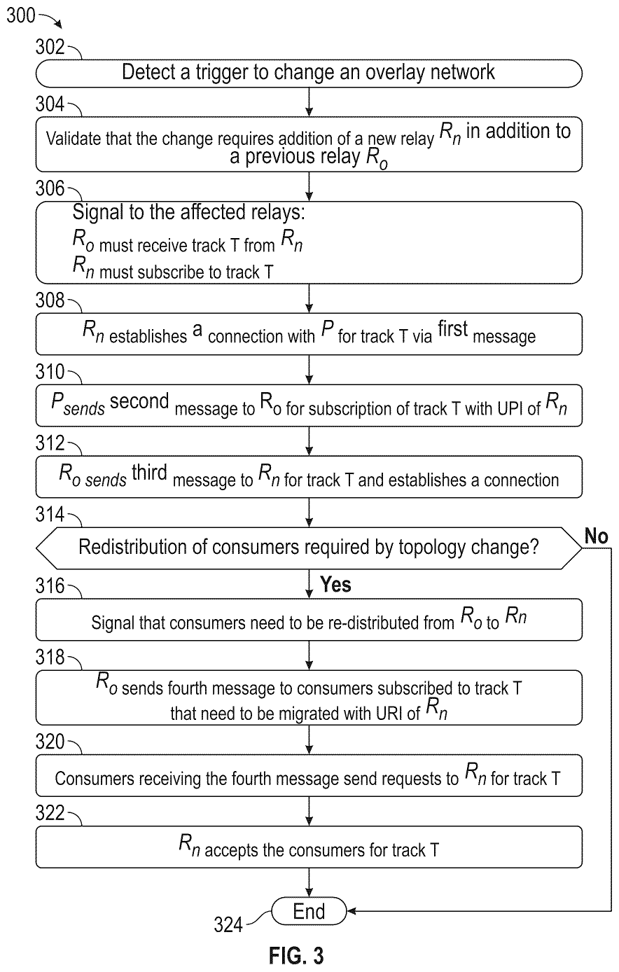

FIG. 3 shows a flowchart of illustrative steps for enabling the reconfiguration of an overlay network, in accordance with some embodiments of the disclosure. Process 300 may be implemented, in whole or in part, on any of the computing devices mentioned herein. In addition, one or more actions of the process 300 may be incorporated into or combined with one or more actions of any other processes or embodiments described herein.

FIG. 3 describes a high-level method for enabling the topology reconfiguration described in FIGS. 2A and 3B. This method may be enabled using a centralized controller, albeit implemented in a distributed manner, where each actor, i.e., an endpoint for one or more QUIC connections in the MOQT overlay network, behaves collusively.

At step 302, a trigger to change an overlay network is detected, for example, a trigger to change the MOQT overlay network. Another example of a change to the overlay network is a trigger to reconfigure an overlay network. This could, for example, be received by all the actors from a centralized controller that calculates an optimal path for delivery of a track T from producers to consumers. At step 304, it is validated that the change requires the addition of a new relay in addition to a previous relay (such as an already existing active relay), for example, the addition of a new relay between a producer computing device and the previous relay. In an example, all the actors validate that the topology change advised is feasible based on their view of the overlay network. In this example, relay Rₒ and producer P may validate their proximity to proposed relay Rₙ and vice versa. In some examples, the proximity may be a network proximity, such as a number of hops between the relay Rₒ and producer P and the proposed relay Rₙ and vice versa. In another example, the proximity may be a geographical proximity between the relay Rₒ and producer P and the proposed relay Rₙ and vice versa. At step 306 a signal is transmitted to the affected relays. For example, a signal is transmitted directly on a control plane (a bidirectional QUIC stream) to the affected relays. In this example, the signal indicates that the previous relay must receive a track from the new relay rather than the producer computing device, and that the new relay must subscribe to the track. In this example, after validation, Rₒ must begin receiving the track T. Further, Rₒ must reconfigure its subscription of track T to receive it from Rn rather than directly from P.

At step 308, the new relay establishes a connection, such as a QUIC connection, with the producer computing device for the track via a first message, such as a SUBSCRIBE message. Thus, in this example, Rₙ establishes a QUIC connection with P via a SUBSCRIBE message for track T. At step 310, the producer computing device sends a second message, such as a GOAWAY message, to the previous relay for a subscription of the track with a URI of the new relay. In this example, P sends a GOAWAY message to Rₒ with a URI of Rₙ. At step 312, the previous relay sends a third message, such as a SUBSCRIBE message, to the new relay device for the track and establishes a connection, such as a QUIC connection. In this example, Rₒ sends a SUBSCRIBE message to Rₙ for track T. In this manner, the relay topology may be reconfigured. In some examples, Rₒ may query Rₙ to check whether it is subscribed to the correct track. Upon receiving a positive response, Rₒ may provide its cached items relevant to the subscribed track to Rₙ. In some examples, a GOAWAY message may be associated with a condition. Examples of such a condition include: after a relay provides cached content; after a relay transfers cached content; after a relay receives confirmation that none of the cached content at the relay is needed; and/or after a transfer of cached content from the relay has been completed.

In some examples, if a client is streaming content from a particular relay node, a change in the overlay topology may impact where the client is going to be pulling or fetching (HTTP request) content from. Typically, a manifest re-write with the updated URIs is shared with the client, if needed. An impacted node may interface with an external system, such as an advertisement network and/or server to receive (e.g., directly) advertisements for a media and/or streaming session (or sessions). In this example, advertisements (or any other supplemental content) may be available for a client associated with the media and/or streaming session (or sessions). When there is a change in the overlay topology, data may be transmitted to the external system (such as, for example, the advertisement network and/or server) to inform the external system, and to give the external system the location of the relay that is taking over.

If, for example, an advertisement server is personalizing advertisements for different steaming sessions (e.g., real-time bidding), and a change in the overlay topology comprises inserting a new relay node such that some of the clients are migrated to the new relay, then data may be transmitted to the advertisement server that indicates which client streaming session IDs were migrated to the newly inserted or instantiated relay node. This may be similar to a one-time HTTP redirect that is valid for the sessions and/or until another redirect is received.

At step 314, it is determined whether a redistribution of consumer computing devices is required by a topology change, for example, a redistribution of consumers between old and new relays. If, at step 314, it is determined that a redistribution is not required, then the process proceeds to step 324, where it ends. If, at step 314, it is determined that a redistribution is required, then the process proceeds to step 316. At step 316, it is signaled, for example, on a control plane, that the consumer computing devices need to be re-distributed from the previous relay to the new relay. In some examples, this may comprise signaling a list of identifications (IDs) of the consumer computing devices to be re-distributed. In this example, to enable this change, a list of consumer IDs to be redistributed (migrated) between Rₒ and Rₙ is provided to the relays on the control plane, typically via a separate protocol.

At step 318, the previous relay sends a fourth message, for example a GOAWAY message, to the consumer computing devices, for example to the consumer IDs in the list, subscribed to the track that need to be migrated with a URI of the new relay. In this example, the relay that needs downstream entities to be migrated away to another relay sends a GOAWAY message selectively to the subscribed consumers that need to be migrated, along with the URI of the new relay. At step 320, the consumer computing devices receiving the fourth message, for example the GOAWAY message, send requests, such as SUBSCRIBE requests, to the new relay for the track. In this example, the consumers that selectively receive these GOAWAY messages subsequently send SUBSCRIBE requests to the new relay. At step 322, the new relay accepts the consumer computing devices for the track, for example, with a SUBSCRIBE_OK message. A SUBSCRIBE_OK message is a message used to confirm a successful subscription to a media stream or data channel. In this example, the new relay admits the consumer for a subscription to track T via a SUBSCRIBE_OK message. In this manner, the MOQT protocol may be intelligently leveraged to reconfigure an overlay network. In particular, the MOQT protocol may be intelligently leveraged to reconfigure an overlay network when an out-of-band determination is made to alter the overlay network based on network conditions and media, for example, a content item, and delivery considerations.

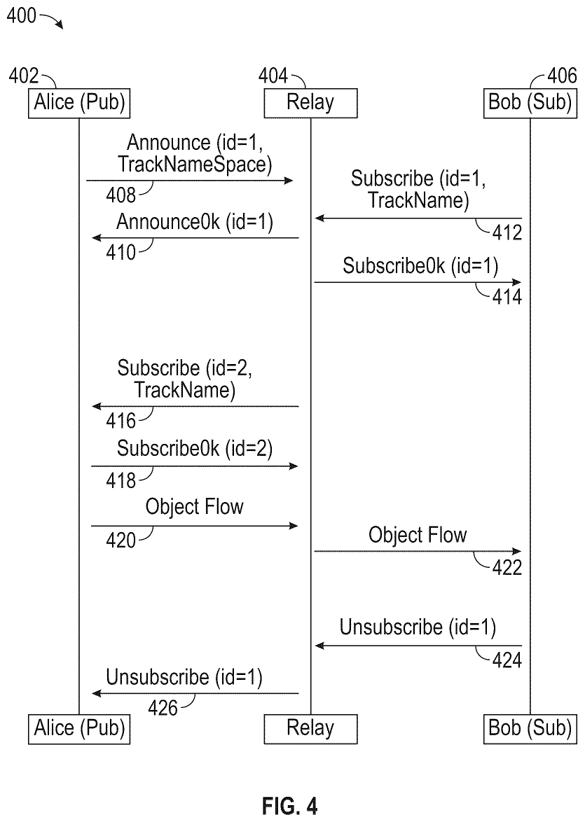

FIG. 4 shows a flow diagram of illustrative steps for enabling the reconfiguration of an overlay network. Process 400 may be implemented, in whole or in part, on any of the computing devices mentioned herein. In addition, one or more actions of the process 400 may be incorporated into or combined with one or more actions of any other processes or embodiments described herein.

The process 400 comprises Alice (a producer computing device) 402, a relay computing device 404, and Bob (a consumer computing device) 406. Alice 402 transmits a MOQT ANNOUNCE message 408, which may comprise a namespace under which she is going to publish tracks, such as content items, to the relay computing device 404. The relay computing device 404 transmits an ANNOUNCE_OK message 410 to Alice 402, acknowledging receipt of the ANNOUNCE message 408. Bob 406 transmits a first SUBSCRIBE message 412, which comprises a request to receive a content item, to the relay computing device 404. The first SUBSCRIBE message 412 may also comprise a FullTrackName (identified by its TrackNamespace and TrackName). The relay computing device 404 transmits a first SUBSCRIBE_OK message 414 to Bob 406, acknowledging receipt of the first SUBSCRIBE message 412.

The relay computing device 404 makes a downstream subscription via a second SUBSCRIBE message 416 to Alice 402, since the track namespace in the first SUBSCRIBE message 412 matches the track namespace in the ANNOUNCE message 408 from Alice 402. Alice 402 responds by transmitting a second SUBSCRIBE_OK message 418 to the relay computing device 404, and transmits the requested object 420, such as a media content item, to the relay computing device 404. The relay computing device 404 transmits the object 422 to Bob 406. After receiving the object, Bob responds by transmitting a first UNSUBSCRIBE message 424 to the relay computing device 404, and the relay computing device 404 transmits the UNSUBSCRIBE message to Alice 402.

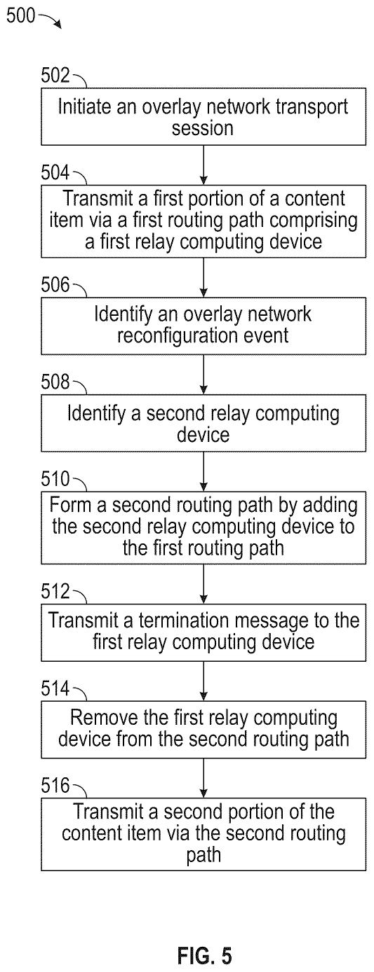

FIG. 5 shows another flowchart of illustrative steps for enabling the reconfiguration of an overlay network, in accordance with some embodiments of the disclosure. Process 500 may be implemented, in whole or in part, on any of the computing devices mentioned herein. In addition, one or more actions of the process 500 may be incorporated into or combined with one or more actions of any other processes or embodiments described herein.

At step 502, an overlay network transport session is initiated, and at step 504, a first portion of a content item is transmitted via a first routing path comprising a first relay computing device. At step 506, an overlay network reconfiguration event is identified, and at step 508, a second relay computing device is identified. At step 510, a second routing path is formed by adding the second relay computing device to the first routing path, and at step 512, a termination message is transmitted to the first relay computing device. At step 514, the first relay computing device is removed from the second routing path, and at step 516, a second portion of the content item is transmitted via the second routing path.

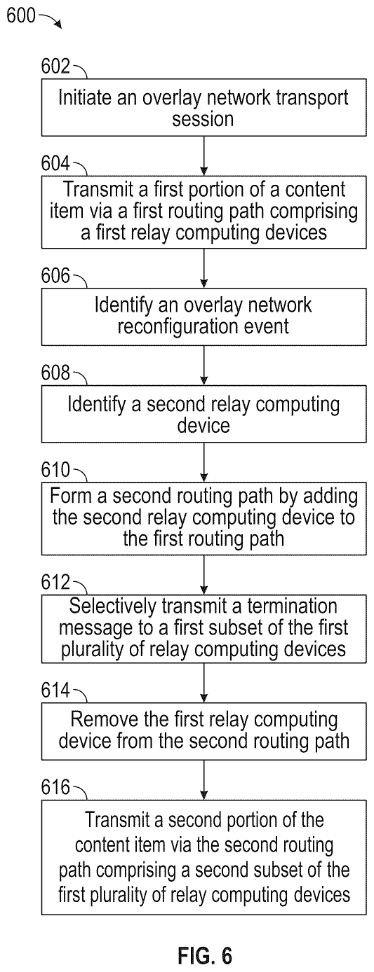

FIG. 6 shows another flowchart of illustrative steps for enabling the reconfiguration of an overlay network, in accordance with some embodiments of the disclosure. Process 600 may be implemented, in whole or in part, on any of the computing devices mentioned herein. In addition, one or more actions of the process 600 may be incorporated into or combined with one or more actions of any other processes or embodiments described herein.

At step 602, an overlay network transport session is initiated, and at step 604, a first portion of a content item is transmitted via a first routing path comprising a first plurality of relay computing devices. At step 606, an overlay network reconfiguration event is identified, and at step 608, a second relay computing device is identified. At step 610, a second routing path is formed by adding the second relay computing device to the first routing path, and at step 612, a termination message is selectively transmitted to a first subset of the first plurality of relay computing devices. In some examples, the first subset of the first plurality of relay computing devices subscribe to the track by transmitting one or more subscribe messages to a new relay URI that is embedded in the termination message. At step 614, the first relay computing device is removed from the second routing path. In some examples, removing the first relay computing device from the second routing path may comprise initiating a subscription from the first subset of the first plurality of relay computing devices receiving a termination message to join the second routing path via the second relay computing device. At step 616, a second portion of the content item is transmitted via the second routing path comprising a second subset of the first plurality of relay computing devices.

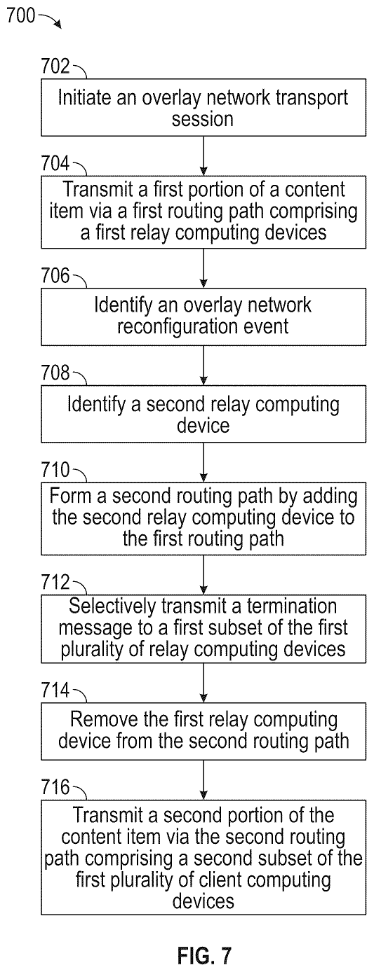

FIG. 7 shows another flowchart of illustrative steps for enabling the reconfiguration of an overlay network, in accordance with some embodiments of the disclosure. Process 700 may be implemented, in whole or in part, on any of the computing devices mentioned herein. In addition, one or more actions of the process 700 may be incorporated into or combined with one or more actions of any other processes or embodiments described herein.

At step 702, an overlay network reconfiguration event is identified, and at step 704, a first portion of a content item is transmitted via a first routing path comprising a first plurality of client computing devices. At step 706, an overlay network reconfiguration event is identified, and at step 708, a second relay computing device is identified. At step 710, a second routing path is formed by adding the second relay computing device to the first routing path, and at step 712, a termination message is selectively transmitted to a first subset of the first plurality of client computing devices. At step 714, the first relay computing device is removed from the second routing path, and at step 716, a second portion of the content item is transmitted via the second routing path comprising a second subset of the first plurality of client computing devices.

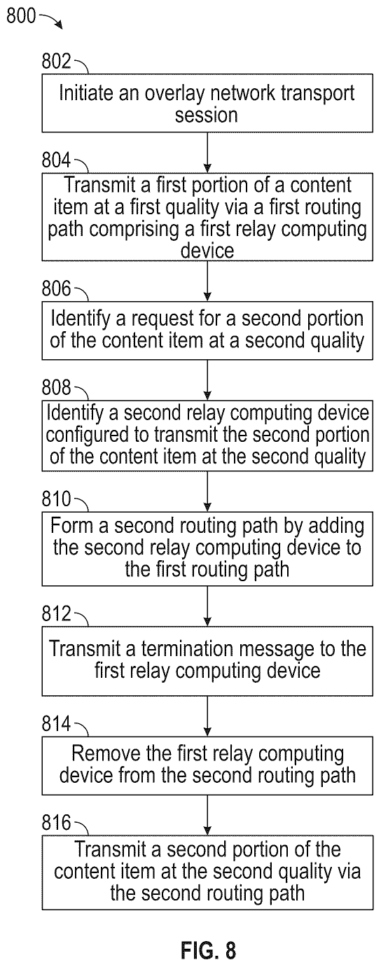

FIG. 8 shows another flowchart of illustrative steps for enabling the reconfiguration of an overlay network, in accordance with some embodiments of the disclosure. Process 800 may be implemented, in whole or in part, on any of the computing devices mentioned herein. In addition, one or more actions of the process 800 may be incorporated into or combined with one or more actions of any other processes or embodiments described herein.

At step 802, an overlay network reconfiguration event is identified, and at step 804, a first portion of a content item at a first quality is transmitted via a first routing path comprising a first relay computing device. At step 806, a request for a second portion of the content item at a second quality is identified, and at step 808, a second relay computing device configured to transmit the second portion of the content item at the second quality is identified. At step 810, a second routing path is formed by adding the second relay computing device to the first routing path, and at step 812, a termination message is transmitted to the first relay computing device. At step 814, the first relay computing device is removed from the second routing path, and at step 816, a second portion of the content item at the second quality is transmitted via the second routing path. The first quality may be a relatively low quality, and the second quality may be a relatively high quality.

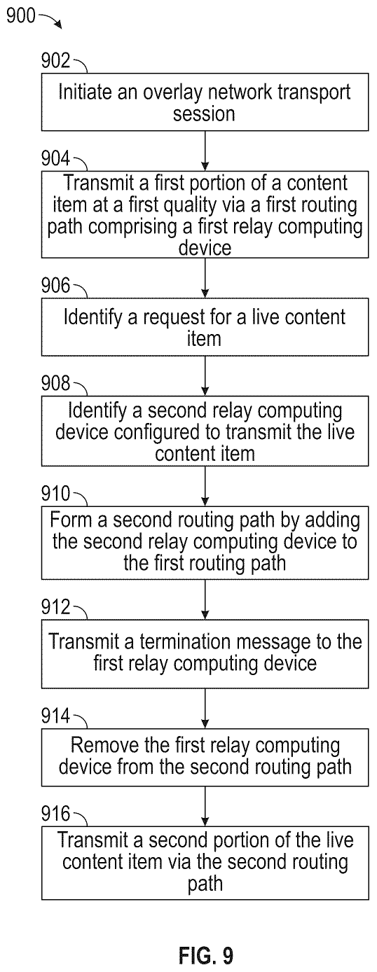

FIG. 9 shows another flowchart of illustrative steps for enabling the reconfiguration of an overlay network, in accordance with some embodiments of the disclosure. Process 900 may be implemented, in whole or in part, on any of the computing devices mentioned herein. In addition, one or more actions of the process 900 may be incorporated into or combined with one or more actions of any other processes or embodiments described herein.

At step 902, an overlay network reconfiguration event is identified, and at step 904, a first portion of an on-demand content item is transmitted via a first routing path comprising a first relay computing device. At step 906, a request for a live content item is identified, and at step 908, a second relay computing device configured to transmit the live content item is identified. At step 910, a second routing path is formed by adding the second relay computing device to the first routing path, and at step 912, a termination message is transmitted to the first relay computing device. At step 914, the first relay computing device is removed from the second routing path, and at step 916, a second portion of the live content item is transmitted via the second routing path.

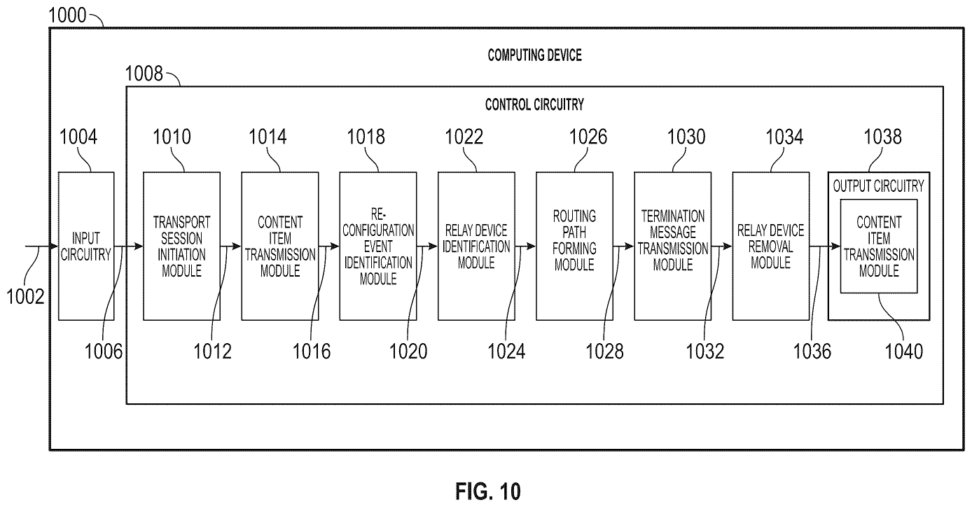

FIG. 10 shows a block diagram representing components of a computing device and dataflow therebetween for enabling the reconfiguration of an overlay network, in accordance with some embodiments of the disclosure. Computing device 1000 comprises input circuitry 1004, control circuitry 1008 and output circuitry 1038. The computing device 1000 may be, for example, a server. Control circuitry 1008 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 8 processor). Some control circuits may be implemented in hardware, firmware, or software.

First input is received 1002 by the input circuitry 1004. The input circuitry 1004 is configured to receive inputs related to a computing device. For example, this may be via a keyboard and a mouse. In other examples, the input may be received via a touchscreen, an infrared controller, a Bluetooth and/or Wi-Fi controller of the computing device 1000, and/or a microphone. In another example, this may be via a gesture detected via an extended reality device. In a further example, the input may comprise instructions received via another computing device. The input circuitry 1004 transmits 1006 the user input to the control circuitry 1008.

The control circuitry 1008 comprises a transport session initiation module 1010, a first content item transmission module 1014, a reconfiguration event identification module 1018, a relay device identification module 1022, a routing path forming module 1026, a termination message transmission module 1030, a relay device removal module 1034 and output circuitry 1038 comprising a second content item transmission module 1040. The first input is transmitted 1006 to the transport session initiation module 1010, where an overlay network transport session is initiated. An indication of the initiation is transmitted 1012 to the first content item transmission module 1014, where a first portion of a content item is transmitted via a first routing path comprising a first relay computing device. An indication that the transmission is ongoing is transmitted 1016 to the reconfiguration event identification module 1018, where a reconfiguration event is identified. An indication of the reconfiguration event is transmitted 1020 to the relay device identification module 1022, where a second relay device is identified based on the overlay network reconfiguration event. An indication of the second relay device is transmitted 1024 to the routing path forming module 1026, where a second routing path is formed by adding, to the first routing path, the second relay computing device. An indication of the second routing path is transmitted 1028 to the termination message transmission module 1030, where a termination message is transmitted to the first relay device (not shown). An indication that the termination message has been transmitted to the first relay device is transmitted 1032 to the relay device removal module 1034, where the first relay device is removed from the second routing path. An indication that the first relay device has been removed is transmitted 1036 to the output circuitry 1038, where the second content item transmission module 1040 transmits a second portion of the content item via the second routing path comprising the second relay computing device.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method of configuring an overlay network, the method comprising:
initiating, at a first relay computing device of the overlay network, a transport session;
transmitting, via a first routing path comprising the first relay computing device, a first portion of a content item;
identifying an overlay network reconfiguration event;
identifying, based on the overlay network reconfiguration event, a second relay computing device;
forming a second routing path by adding, to the first routing path, the second relay computing device;
transmitting, to the first relay computing device, a termination message indicating that the transport session must be ended;
removing, based on the termination message, the first relay computing device from the second routing path; and
transmitting, via the second routing path comprising the second relay computing device, a second portion of the content item.

2. The method of claim 1, wherein identifying the overlay network reconfiguration event comprises:
receiving a heartbeat signal; and
identifying a change in the heartbeat signal.

3. The method of claim 1, wherein the method further comprises:
receiving a plurality of heartbeat signals from each of a plurality of second relay computing devices; and
selecting, based on the plurality of heartbeat signals, the second relay computing device from the plurality of second relay computing devices.

4. The method of claim 1, wherein the first routing path comprises a first plurality of relay computing devices of the overlay network and wherein:
transmitting the first portion of the content item further comprises transmitting the first portion of the content item via the first routing path comprising the first plurality of relay computing devices;
transmitting the termination message further comprises selectively transmitting the termination message to a first subset of the first plurality of relay computing devices;
removing the first relay computing device from the second routing path further comprises removing the first subset of the first plurality of computing devices; and
transmitting the second portion of the content item further comprises transmitting the second portion of the content item via the second routing path comprising a second subset of the first plurality of relay computing devices, wherein the first subset and the second subset of relay computing devices are different.

5. The method of claim 4, wherein the method further comprises transmitting a SUBSCRIBE message to at least one relay computing device of the second subset of the plurality of relay computing devices.

6. The method of claim 1, wherein the first routing path further comprises a first plurality of client computing devices and wherein:
transmitting the first portion of the content item further comprises transmitting the first portion of the content item to the first plurality of client computing devices;
transmitting the termination message further comprises selectively transmitting the termination message to a first subset of the first plurality of client computing devices; and
transmitting the second portion of the content item further comprises transmitting the second portion of the content item to a second subset of the first plurality of client computing devices, wherein the first subset and the second subset of client computing devices are different.

7. The method of claim 6, wherein the method further comprises transmitting a SUBSCRIBE message to the second subset of client computing devices.

8. The method of claim 1, wherein:
the first portion of the content item is at a first quality;
identifying the overlay network reconfiguration event further comprises identifying a request for a second portion of the content item at a second quality;
identifying the second relay computing device further comprises identifying the second relay computing device based on identifying that the second relay computing device is configured to transmit the second portion of the content item at the second quality; and
transmitting the second portion of the content item further comprises transmitting the second portion of the content item at the second quality.

9. The method of claim 1, wherein identifying the overlay network reconfiguration event comprises:
identifying a change in network performance of a connection between the first relay computing device and another computing device in the first routing path; and
determining that the change in network performance of the connection is above a threshold.

10. The method of claim 1, wherein:
the content item is an on-demand content item;
identifying the overlay network reconfiguration event further comprises identifying a request for a live content item;
identifying the second relay computing device further comprises identifying the second relay computing device based on identifying that the second relay computing device is configured to transmit a second portion of the live content item; and
transmitting the second portion of the content item further comprises transmitting the second portion of the live content item.

11. A system comprising:
input/output circuitry configured to:
initiate, at a first relay computing device of the overlay network, a transport session; and
transmit, via a first routing path comprising the first relay computing device, a first portion of a content item; and
processing circuitry configured to:
identify an overlay network reconfiguration event;
identify, based on the overlay network reconfiguration event, a second relay computing device;
form a second routing path by adding, to the first routing path, the second relay computing device;
transmit, to the first relay computing device, a termination message indicating that the transport session must be ended;
remove, based on the termination message, the first relay computing device from the second routing path; and
transmit, via the second routing path comprising the second relay computing device, a second portion of the content item.

12. The system of claim 11, wherein the processing circuitry configured to identify the overlay network reconfiguration event is further configured to:
receive a heartbeat signal; and
identify a change in the heartbeat signal.

13. The system of claim 11, wherein the processing circuitry is further configured to:
receive a plurality of heartbeat signals from each of a plurality of second relay computing devices; and
select, based on the plurality of heartbeat signals, the second relay computing device from the plurality of second relay computing devices.

14. The system of claim 11, wherein the first routing path comprises a first plurality of relay computing devices of the overlay network and wherein:
the processing circuitry configured to transmit the first portion of the content item is further configured to transmit the first portion of the content item via the first routing path comprising the first plurality of relay computing devices;
the processing circuitry configured to transmit the termination message is further configured to selectively transmit the termination message to a first subset of the first plurality of relay computing devices;
the processing circuitry configured to remove the first relay computing device from the second routing path is further configured to remove the first subset of the first plurality of computing devices; and
the processing circuitry configured to transmit the second portion of the content item is further configured to transmit the second portion of the content item via the second routing path comprising a second subset of the first plurality of relay computing devices, wherein the first subset and the second subset of relay computing devices are different.

15. The system of claim 14, wherein the processing circuitry is further configured to transmit a SUBSCRIBE message to at least one relay computing device of the second subset of the plurality of relay computing devices.

16. The system of claim 11, wherein the first routing path further comprises a first plurality of client computing devices and wherein:
the input/output circuitry configured to transmit the first portion of the content item is further configured to transmit the first portion of the content item to the first plurality of client computing devices;
the processing circuitry configured to transmit the termination message is further configured to selectively transmit the termination message to a first subset of the first plurality of client computing devices; and
the processing circuitry configured to transmit the second portion of the content item is further configured to transmit the second portion of the content item to a second subset of the first plurality of client computing devices, wherein the first subset and the second subset of client computing devices are different.

17. The system of claim 16, wherein the processing circuitry is further configured to transmit a SUBSCRIBE message to the second subset of client computing devices.

18. The system of claim 11, wherein:
the first portion of the content item is at a first quality;
the processing circuitry configured to identify the overlay network reconfiguration event is further configured to identify a request for a second portion of the content item at a second quality;
the processing circuitry configured to identify the second relay computing device is further configured to identify the second relay computing device based on identifying that the second relay computing device is configured to transmit the second portion of the content item at the second quality; and
the processing circuitry configured to transmit the second portion of the content item is further configured to transmit the second portion of the content item at the second quality.

19. The system of claim 11, wherein the processing circuitry configured to identify the overlay network reconfiguration event is further configured to:
identify a change in network performance of a connection between the first relay computing device and another computing device in the first routing path; and
determine that the change in network performance of the connection is above a threshold.

20. The system of claim 11, wherein:
the content item is an on-demand content item;
the processing circuitry configured to identify the overlay network reconfiguration event is further configured to identify a request for a live content item;
the processing circuitry configured to identify the second relay computing device is further configured to identify the second relay computing device based on identifying that the second relay computing device is configured to transmit a second portion of the live content item; and
the processing circuitry configured to transmit the second portion of the content item is further configured to transmit the second portion of the live content item.

21-50. (canceled)
